(19) United States
(12) Patent Application Publication
(10) Pub. No.: US 2011/0102954 A1
(43) Pub. Date: May 5, 2011

(54) SEMICONDUCTOR INTEGRATED CIRCUIT

(76) Inventors: Katsuya ARAI, Kyoto (JP); Toshihiro Kougami, Kyoto (JP)

(21) Appl. No.: 12/819,512

(22) Filed: Jun. 21, 2010

(30) Foreign Application Priority Data
Oct. 30, 2009 (JP) 2009-250019

(51) Int. Cl. H02H 9/04

(52) U.S. Cl. 361/56

(57) ABSTRACT

A semiconductor integrated circuit includes a first functional circuit block; a second functional circuit block; a relay circuit block; a first protection circuit block; and a second protection circuit block. The first protection circuit block includes an ESD protection circuit connected between either one of a first high-voltage power supply line and a first low-voltage power supply line, and either one of a third high-voltage power supply line and a third low-voltage power supply line. The second protection circuit block includes an ESD protection circuit connected between either one of a second high-voltage power supply line and a second low-voltage power supply line, and either one of the third high-voltage power supply line and the third low-voltage power supply line.

### CROSS-REFERENCE TO RELATED APPLICATION

This application claims priority to Japanese Patent Application No. 2009-250019 filed on Oct. 30, 2009, the disclosure of which including the specification, the drawings, and the claims is hereby incorporated by reference in its entirety.

### BACKGROUND

The present disclosure relates to a semiconductor integrated circuit, and particularly relates to a semiconductor integrated circuit including a plurality of power supply lines.

With recent progress in high-density integration of semiconductor integrated (LSI) circuits and in a digital technology, digital and analog circuits are formed in a single LSI chip for many LSI circuits. The digital and analog circuits are generally operated at different voltages. Thus, it is necessary to provide a plurality of power supply lines for supplying different voltages in the LSI chip. In the LSI chip including the plurality of power supply lines, electrostatic discharge (ESD) protection design is required, which is different from a design in a circuit including only a single power supply line. Specifically, an ESD protection circuit should be designed so that all of internal circuits are not damaged due to ESD current supplied from each of power supply terminals. In addition, with recent progress in miniaturization of a semiconductor device, high-performance LSI circuits have been developed, thereby increasing the number of circuit blocks in a single chip. In addition to the above, the number of power supply lines required in a single chip has been also increased. For example, in a LSI circuit for, e.g., video systems or digital video discs, there may be more than 20 types of power supply lines. In such a case, it is necessary to provide an ESD protection circuit for each power supply line.

For system LSI, ESD protection circuits are generally formed in an IO cell area provided around an internal area in which circuit blocks are formed. If ESD is generated in a particular power supply terminal, surge current flows to ground through the IO cell area in which the ESD protection circuits are formed. In such a case, ESD voltage Vesd applied between the power supply terminal where the ESD is generated and a ground terminal through which the surge current passes is determined depending on current-voltage properties of the ESD protection circuits on a path through which the surge current flows. Specifically, the ESD voltage Vesd is represented by the following expression (1):

Vesd=(Resd-total+Rmetal-total)×Iesd+Vh-total (1)

where the parameter “Resd-total” represents the total of on-state resistances of the ESD protection circuits on the electrical discharge path; the parameter “Rmetal-total” represents the total of interconnection resistances on the electrical discharge path; the parameter “Iesd” represents ESD peak current; and the parameter “Vh-total” represents the total of holding voltages of the ESD protection circuits on the electrical discharge path.

Thus, a longer electrical discharge path results in an increase in the interconnection resistance total Rmetal-total, thereby increasing the ESD voltage Vesd. In addition, the larger number of ESD protection circuit stages on the electrical discharge path results in an increase in the ESD protection circuit on-state resistance total Resd-total and the holding voltage total Vh-total, thereby increasing the ESD voltage Vesd. In general, contribution to the ESD voltage Vesd by the ESD protection circuit on-state resistance total Resd-total and the holding voltage total Vh-total is greater than contribution to the ESD voltage Vesd by the interconnection resistance total Rmetal-total. Thus, the ESD voltage Vesd is determined depending on the current-voltage properties of the ESD protection circuits on the electrical discharge path.

The ESD voltage Vesd is applied not only between the power supply terminal and the ground terminal, but also to an input terminal of the circuit block through a signal line. If the ESD voltage Vesd exceeds the input terminal breakdown voltage, i.e., the gate oxide film breakdown voltage of a transistor connected to the input terminal, the transistor is damaged. The increase in the number of power supply lines results in the increase in the number of ESD protection circuits, whereas the device miniaturization results in a decrease in the transistor breakdown voltage such as the gate oxide film breakdown voltage and the drain breakdown voltage. This tends to cause the transistor damage through the signal line.

Particularly, in a semiconductor integrated circuit including more than two types of power supply lines, it has been known as an ESD protection method in interface sections that an ESD protection circuit is inserted into a signal interface section between circuit blocks including different power supply lines (see, e.g., Japanese Patent Publication No. 2006-238074).

FIG. 5 illustrates an conventional ESD protection circuit inserted into an interface section between circuit blocks connected to power supplies with different voltages. As illustrated in FIG. 5, resistance r is inserted into the middle of a signal line connecting between a circuit s1 connected to a power supply E1 and a circuit s2 connected to a power supply E2. In addition, a p-type metal-oxide-semiconductor (MOS) transistor p is connected between the signal line and a power supply line E2 of an input-side circuit block, and an nMOS transistor n is connected between the signal line and ground. The ESD protection circuit is inserted into the signal line itself. Thus, even if the ESD voltage Vesd is applied not only to the original electrical discharge path formed in the IO cell area etc., but also to the signal line, the transistor of the input-side circuit block is not damaged.

### SUMMARY

However, the conventional ESD protection circuit is inserted into the signal line. This brings about a state in which capacitance and resistance are added to the signal line, thereby causing a signal delay which results in a difficulty in high-speed signal propagation. In the recent system LSI, a gigahertz operation is required, and it is difficult to use the above-described method.

It is an object of the present disclosure to solve the above-described problem in order to provide a semiconductor integrated circuit having excellent ESD resistance without sacrificing the high-speed signal propagation.

In the present disclosure, the semiconductor integrated circuit has a configuration in which two functional circuit blocks are connected to each other through a relay circuit block, and a protection circuit block is provided between the functional circuit block and the relay circuit block.

Specifically, the semiconductor integrated circuit provided as an example includes a first functional circuit block including a first functional circuit; a second functional circuit block including a second functional circuit which receives output signals from the first functional circuit; a relay circuit block including a relay circuit, which is provided between the first and second functional circuit blocks; a first protection circuit block including a first ESD protection circuit, which is provided between the first functional circuit block and the relay circuit block; and a second protection circuit block including a second ESD protection circuit, which is provided between the second functional block and the relay circuit block. The first functional circuit is connected between a first high-voltage power supply line and a first low-voltage power supply line. The second functional circuit is connected between a second high-voltage power supply line and a second low-voltage power supply line. The relay circuit is connected between a third high-voltage power supply line and a third low-voltage power supply line. An output terminal of the first functional circuit is connected to an input terminal of the relay circuit through a first signal line. An output terminal of the relay circuit is connected to an input terminal of the second functional circuit through a second signal line. The first ESD protection circuit is connected between either one of the first high-voltage power supply line and the first low-voltage power supply line, and either one of the third high-voltage power supply line and the third low-voltage power supply line. The second ESD protection circuit is connected between either one of the second high-voltage power supply line and the second low-voltage power supply line, and either one of the third high-voltage power supply line and the third low-voltage power supply line.

In the semiconductor integrated circuit provided as an example, ESD voltage applied to the signal line is distributed by the relay circuit. Thus, the voltage applied to the input terminal of the second functional circuit when generating ESD can be reduced as compared to the voltage when the relay circuit block is not provided. In addition, unlike the case where the electrostatic discharge protection circuit is inserted into the signal line, an advantage can be realized, in which the signal delay due to the addition of the capacitance and resistance is not caused.

### BRIEF DESCRIPTION OF THE DRAWINGS

FIG. 1 is a circuit diagram illustrating a semiconductor integrated circuit of an embodiment.

FIGS. 2(a)-2(f) are circuit diagrams illustrating examples of a protection circuit block of the semiconductor integrated circuit of the embodiment.

FIGS. 3(a) and 3(b) are circuit diagrams illustrating examples of an ESD protection circuit.

FIGS. 4(a) and 4(b) are circuit diagrams illustrating examples of the ESD protection circuit.

FIG. 5 is a circuit diagram illustrating a conventional ESD protection circuit.

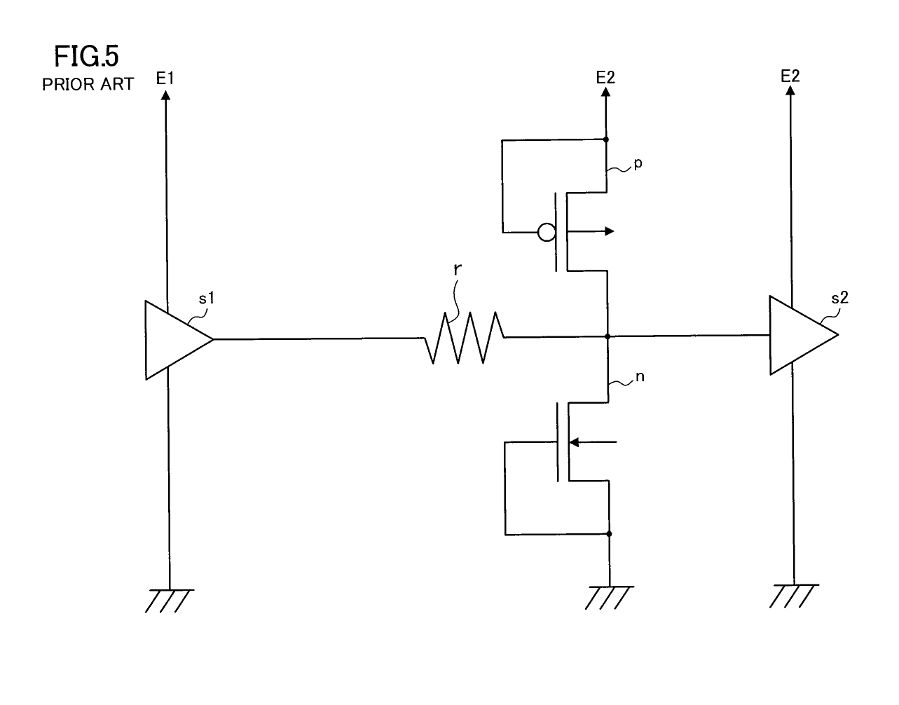

### DETAILED DESCRIPTION

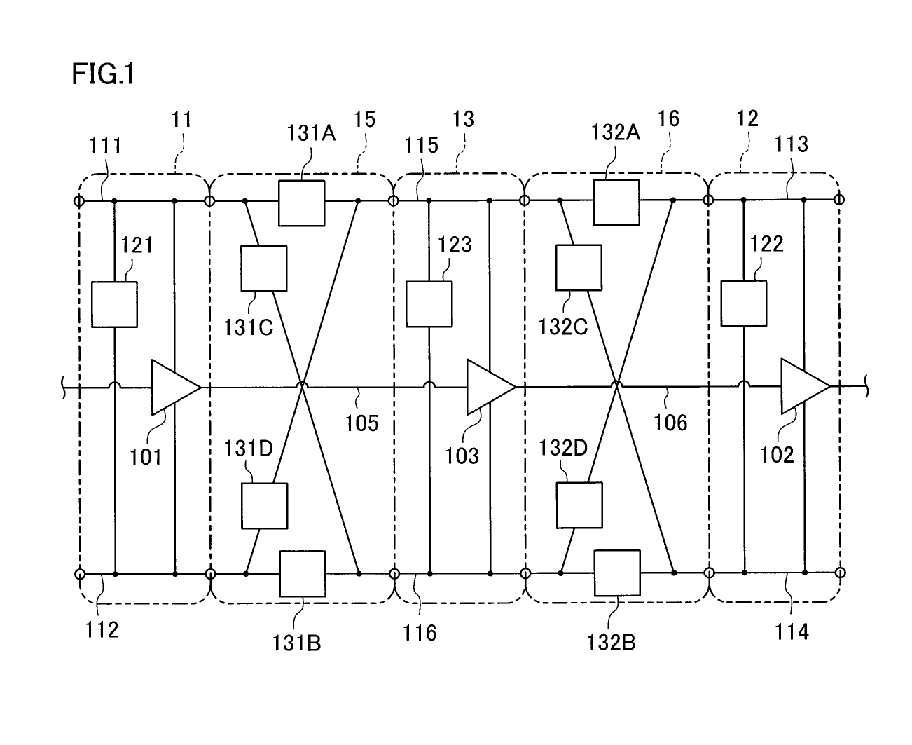

FIG. 1 illustrates a circuit configuration of a semiconductor integrated circuit of an embodiment. As illustrated in FIG. 1, the semiconductor integrated circuit includes a first functional circuit block 11; a second functional circuit block 12; and a relay circuit block 13 for transferring signals between the first functional circuit block 11 and the second functional circuit block 12. A first protection circuit block 15 is provided between the first functional circuit block 11 and the relay circuit block 13, and a second protection circuit block 16 is provided between the relay circuit block 13 and the second functional circuit block 12.

The first functional circuit block 11 includes a first functional circuit 101 connected between a first high-voltage power supply line 111 and a first low-voltage power supply line 112. The second functional circuit block 12 includes a second functional circuit 102 connected between a second high-voltage power supply line 113 and a second low-voltage power supply line 114. The first functional circuit 101 and the second functional circuit 102 may be any types of circuits, and includes, e.g., analog circuits, digital circuits, and memory circuits.

The relay circuit block 13 includes a relay circuit 103 connected between a third high-voltage power supply line 115 and a third low-voltage power supply line 116. An output terminal of the first functional circuit 101 and an input terminal of the relay circuit 103 are connected to each other by a first signal line 105. An output terminal of the relay circuit 103 and an input terminal of the second functional circuit 102 are connected to each other by a second signal line 106. An input terminal of the first functional circuit 101 is connected to an output terminal of another circuit block, or is connected to an external input terminal of the semiconductor integrated circuit. An output terminal of the second functional circuit 102 is connected to an input terminal of another circuit block, or is connected to an external output terminal of the semiconductor integrated circuit. The relay circuit 103 may be, but not limited to, an inverter circuit.

The first protection circuit block 15 includes an ESD protection circuit 131A connected between the first high-voltage power supply line 111 and the third high-voltage power supply line 115; an ESD protection circuit 131B connected between the first low-voltage power supply line 112 and the third low-voltage power supply line 116; an ESD protection circuit 131C connected between the first high-voltage power supply line 111 and the third low-voltage power supply line 116; and an ESD protection circuit 131D connected between the first low-voltage power supply line 112 and the third high-voltage power supply line 115.

The second protection circuit block 16 includes an ESD protection circuit 132A connected between the third high-voltage power supply line 115 and the second high-voltage power supply line 113; an ESD protection circuit 132B connected between the third low-voltage power supply line 116 and the second low-voltage power supply line 114; an ESD protection circuit 132C connected between the third high-voltage power supply line 115 and the second low-voltage power supply line 114; and an ESD protection circuit 132D connected between the third low-voltage power supply line 116 and the second high-voltage power supply line 113.

The first functional circuit block 11 includes an ESD protection circuit 121 connected between the first high-voltage power supply line 111 and first low-voltage power supply line 112; the second functional circuit block 12 includes an ESD protection circuit 122 connected between the second high-voltage power supply line 113 and the second low-voltage power supply line 114; and the relay circuit block 13 includes an ESD protection circuit 123 connected between the third high-voltage power supply line 115 and the third low-voltage power supply line 116.

In FIG. 1, the first high-voltage power supply line 111, the second high-voltage power supply line 113, and the third high-voltage power supply line 115 are separated from each other. The first low-voltage power supply line 112, the second low-voltage power supply line 114, and the third low-voltage power supply line 116 are also separated from each other. The first high-voltage power supply line 111 has potential higher than that of the first low-voltage power supply line 112; the second high-voltage power supply line 113 has potential higher than that of the second low-voltage power supply line 114; and the third high-voltage power supply line 115 has potential higher than that of the third low-voltage power supply line 116. Note that the first high-voltage power supply line 111, and the second high-voltage power supply line 113, and the third high-voltage power supply line 115 may be power supply lines having the same potential. In addition, the first low-voltage power supply line 112, the second low-voltage power supply line 114, and the third low-voltage power supply line 116 may be a common power supply line such as ground. Further, the first low-voltage power supply line 112 and the second high-voltage power supply line 113 may serve as ground; the first high-voltage power supply line 111 may be a power supply line having positive potential; and the second low-voltage power supply line 114 may be a power supply line having negative potential.

FIG. 1 illustrates the example in which each of the first protection circuit block 15 and the second protection circuit block 16 includes the four ESD protection circuits, and each of the first functional circuit block 11, the second functional circuit block 12, and the relay circuit block 13 includes the ESD protection circuit connected between the high-voltage power supply line and the low-voltage power supply line. The protection circuit block is implemented by the four ESD protection circuits, and the power supply lines are connected to each other between the circuit blocks through the ESD protection circuit. This provides an advantage that an electrical discharge path can be the shortest for surge current discharge generated on any paths. The number of ESD protection circuits on the shortest path when flowing surge current between, e.g., the first high-voltage power supply line 111 and the third high-voltage power supply line 115 is one. Similarly, the minimum number of ESD protection circuits is also one between the first high-voltage power supply line 111 and the third low-voltage power supply line 116; between the first low-voltage power supply line 112 and the third low-voltage power supply line 116; and the first low-voltage power supply line 112 and the third high-voltage power supply line 115.

As shown by the expression (1), the smaller number of ESD protection circuits on the path through which the surge current flows results in the decrease in the ESD protection circuit on-state resistance total Resd-total and the holding voltage total Vh-total, thereby reducing the surge voltage Vesd generated by the ESD. Note that, if there is no ESD protection circuit, at least one ESD protection circuit is required because the ESD current cannot be dissipated, and the circuit cannot be protected. For this reason, the circuit protection block is implemented by the four ESD protection circuits as illustrated in FIG. 1, and the minimum number of ESD protection circuits connected between the power supply lines in the adjacent circuit blocks is one, thereby enhancing the effect of reducing the ESD voltage. However, the larger number of ESD protection circuits results in an increase in area occupied by the ESD protection circuits in the semiconductor integrated circuit. For this reason, the number of ESD protection circuits and positions where the ESD protection circuits are inserted may be selected depending on the breakdown voltages of the functional circuits, the path through which the surge current flows, current-voltage properties of the ESD protection circuits, etc.

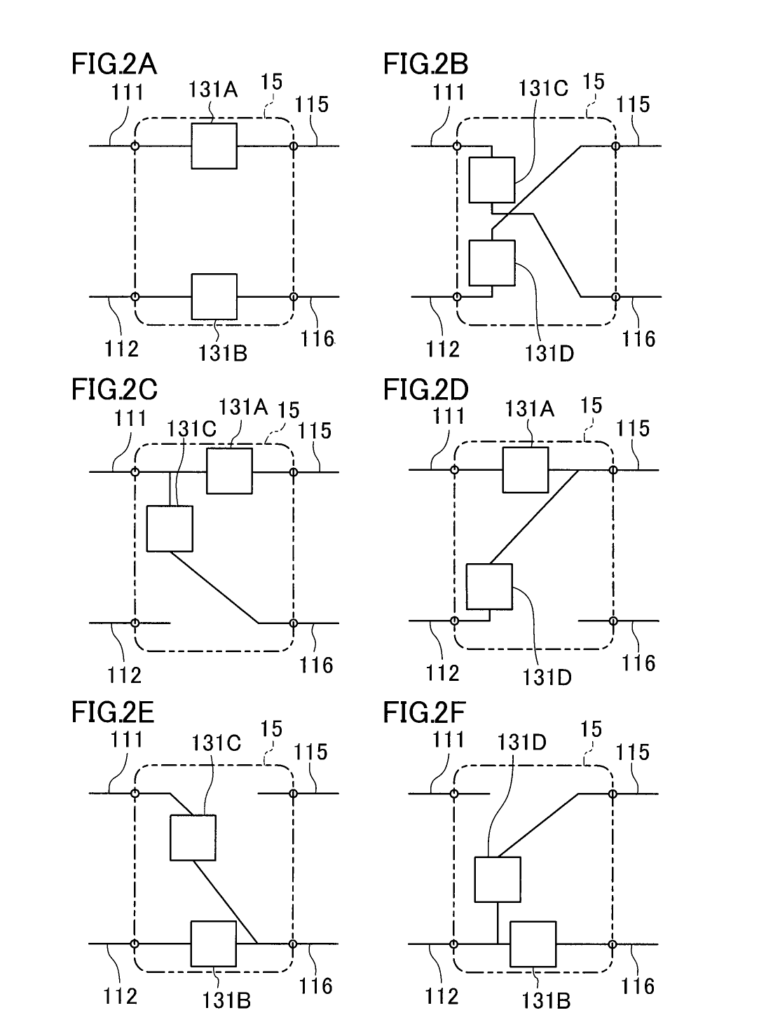

If, e.g., two ESD protection circuits are provided in a first protection circuit block, combinations illustrated in FIGS. 2(a)-2(f) can be realized. For example, a first protection circuit block 15 illustrated in FIG. 2(a) is implemented by an ESD protection circuit 131A connected between a first high-voltage power supply line 111 and a third high-voltage power supply line 115; and an ESD protection circuit 131B connected between a first low-voltage power supply line 112 and a third low-voltage power supply line 116. In addition, in the first protection circuit block 15, an ESD protection circuit 131C and an ESD protection circuit 131D are not provided. If the first protection circuit block 15 including the four ESD protection circuits as illustrated in FIG. 1 is replaced by the first protection circuit block 15 including the two ESD protection circuits as illustrated in FIG. 2(a), the number of ESD protection circuits on the shortest path when flowing surge current between the first high-voltage power supply line 111 and the third low-voltage power supply line 116 is two. However, a path through which the surge current passes through the ESD protection circuit 121 and the ESD protection circuit 131B is provided in parallel with a path through which the surge current passes through the ESD protection circuit 131A and the ESD protection circuit 123. Thus, the voltage generated between the first high-voltage power supply line 111 and the third low-voltage power supply line 116 by the ESD is not simply twice as high as the voltage when the first protection circuit block 15 is implemented by the four ESD protection circuits.

The number of ESD protection circuits may be one or three. That is, in the first protection circuit block 15, there may be at least one ESD protection circuit connected between either one of the first high-voltage power supply line 111 and the first low-voltage power supply line 112 and either one of the third high-voltage power supply line 115 and the third low-voltage power supply line 116. The second protection circuit block 16 may use a configuration similar to that of the first protection circuit block 15. In addition, the first protection circuit block 15 and the second protection circuit block 16 may have the same configuration, or may have different configurations. For example, the first protection circuit block 15 may be implemented by four ESD protection circuits, and the second protection circuit block 16 may be implemented by two ESD protection circuits.

An operation when applying ESD current to the semiconductor integrated circuit of the present embodiment will be described below. For example, suppose that ESD current is applied to the first high-voltage power supply line 111, and flows through the second low-voltage power supply line 114. In addition, each of the first protection circuit block 15 and the second protection circuit block 16 is implemented by four ESD protection circuits. In such a case, voltage V1-3 applied between the first high-voltage power supply line 111 and the third low-voltage power supply line 116 by the ESD is determined depending on the current-voltage properties of the ESD protection circuit connected between the first high-voltage power supply line 111 and the third low-voltage power supply line 116. Voltage V1-2 applied between the first high-voltage power supply line 111 and the second low-voltage power supply line 114 by the ESD is determined depending on the current-voltage properties of the ESD protection circuit connected between the first high-voltage power supply line 111 and the second low-voltage power supply line 114. If the first protection circuit block 15 and the second protection circuit block 16 have the same configuration, the voltage V1-2 is approximately twice as high as the voltage V1-3.

In the semiconductor integrated circuit of the present embodiment, the output terminal of the first functional circuit 101 and the input terminal of the second functional circuit 102 are connected to each other through the relay circuit 103. Thus, when generating the ESD in the first high-voltage power supply line 111, the voltage V1-3 is applied to the input terminal of the relay circuit 103. In addition, voltage equal to a difference between the voltage V1-2 and the voltage V1-3 is applied to the input terminal of the second functional circuit 102. On the other hand, if the output terminal of the first functional circuit 101 and the input terminal of the second functional circuit 102 are directly connected to each other without a relay circuit, the voltage V1-2 is applied to the input terminal of the second functional circuit 102. In this manner, the relay circuit block and the protection circuit blocks are provided between the two functional circuits, thereby allowing reduction in the voltage to be applied to the input terminal of the functional circuit when generating the ESD.

Unlike the case where an ESD protection circuit is inserted into a signal line, the signal line does not have additional capacitance and resistance, thereby not causing a significant signal delay. Although a slight signal delay is caused by inserting the relay circuit 103, the signal delay can be reduced if the relay circuit 103 is an inverter.

In the present embodiment, the configuration is described, in which the single relay circuit block is inserted between the first and second functional circuit blocks. However, a plurality of relay circuit blocks may be inserted between the first and second functional circuit blocks. If the plurality of relay circuit blocks are provided, a protection circuit block may be inserted between the relay circuit blocks. In addition, if the plurality of relay circuit blocks are inserted, an inverter with greater drive capability is preferably used for a block in a later stage. This can reduce delay time while reducing power consumption.

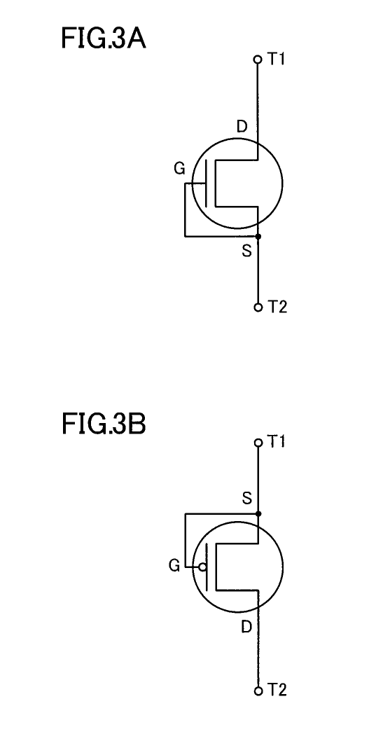

Each of the ESD protection circuits may be a well-known ESD protection circuit. The ESD protection circuit may be, e.g., a circuit using a MOS transistor as illustrated in FIGS. 3(a) and 3(b). The circuits illustrated in FIGS. 3(a) and 3(b) are suitable as an ESD protection circuit connected between two power supply lines having a potential difference. In the nMOS transistor illustrated in FIG. 3(a), it is preferred that a terminal T1 on a drain D side is connected to higher voltages, and a terminal T2 on a source S side connected to a gate G is connected to lower voltages. In the pMOS transistor illustrated in FIG. 3(b), it is preferred that a terminal T1 on a source S side connected to a gate G is connected to higher voltages, and a terminal T2 on a drain D side is connected to lower voltages. Note that the ESD protection circuits illustrated in FIGS. 3(a) and 3(b) may be connected between power supply lines having equal potential.

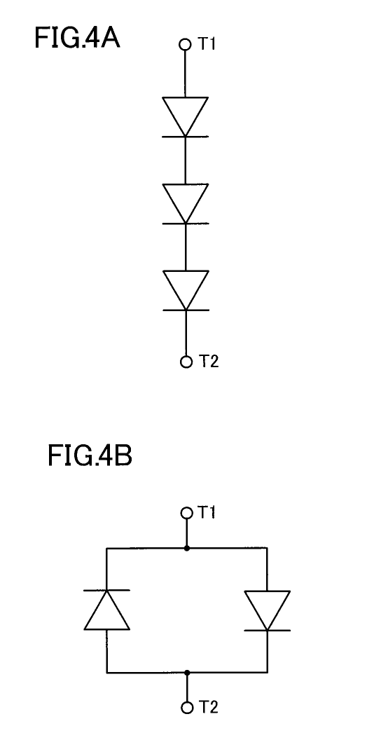

In addition, as illustrated in FIGS. 4(a) and 4(b), diodes may be combined. In FIG. 4(a), the holding voltage can be changed depending on the number of diodes to be connected. In a circuit illustrated in FIG. 4(a), an anode terminal T1 may be connected to higher voltages, and a cathode terminal T2 may be connected to lower voltages. As illustrated in FIG. 4(b), in an ESD protection circuit connected between power supply lines having equal potential, two diodes may be connected in inverse parallel. In such a case, a plurality of diodes are connected in series, and then are connected in inverse parallel, thereby changing the holding voltage. By using such an ESD protection circuit, an ESD protection circuit can be designed, which has the required on-state resistance and holding voltage. In addition, a plurality of ESD protection circuits may be combined.

The current-voltage properties of the ESD protection circuits provided in the first protection circuit block 15 and the second protection circuit block 16 are set as follows. For example, if the ESD current is applied to the first high-voltage power supply line 111, and flows all the way to the second low-voltage power supply line 114, the ESD voltage applied between the first signal line 105 and the third low-voltage power supply line 116 may be lower than the breakdown voltage of the input terminal of the relay circuit 103, and the ESD voltage applied between the second signal line 106 and the second low-voltage power supply line 114 may be lower than the breakdown voltage of the input terminal of the second functional circuit 102. That is, the ESD voltage applied between the first high-voltage power supply line 111 and the third low-voltage power supply line 116 may be lower than the breakdown voltage of the input terminal of the relay circuit 103, and the ESD voltage applied between the third high-voltage power supply line 115 and the second low-voltage power supply line 114 may be lower than the breakdown voltage of the input terminal of the second functional circuit 102.

In the present embodiment, the configuration is described, in which the single protection circuit block is connected between the first functional circuit block and the relay circuit block, and between the relay circuit block and the second functional circuit block. However, the single protection circuit block is not necessarily provided in all sections between the functional circuit blocks. Within allowable ranges of the breakdown voltage etc. of the circuit, a plurality of protection circuit blocks may be provided between two functional circuit blocks.

The semiconductor integrated circuit of the present disclosure can realize a semiconductor integrated circuit having excellent ESD resistance without sacrificing high-speed signal propagation, and is useful particularly as a semiconductor integrated circuit including a plurality of power supply lines.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

What is claimed is:

1. A semiconductor integrated circuit, comprising:
a first functional circuit block including a first functional circuit;
a second functional circuit block including a second functional circuit which receives output signals from the first functional circuit;
a relay circuit block including a relay circuit, which is provided between the first and second functional circuit blocks;
a first protection circuit block including a first ESD protection circuit, which is provided between the first functional circuit block and the relay circuit block; and
a second protection circuit block including a second ESD protection circuit, which is provided between the second functional block and the relay circuit block,
wherein the first functional circuit is connected between a first high-voltage power supply line and a first low-voltage power supply line;
the second functional circuit is connected between a second high-voltage power supply line and a second low-voltage power supply line;
the relay circuit is connected between a third high-voltage power supply line and a third low-voltage power supply line;
an output terminal of the first functional circuit is connected to an input terminal of the relay circuit through a first signal line;
an output terminal of the relay circuit is connected to an input terminal of the second functional circuit through a second signal line;
the first ESD protection circuit is connected between either one of the first high-voltage power supply line and the first low-voltage power supply line, and either one of the third high-voltage power supply line and the third low-voltage power supply line; and
the second ESD protection circuit is connected between either one of the second high-voltage power supply line and the second low-voltage power supply line, and either one of the third high-voltage power supply line and the third low-voltage power supply line.

2. The semiconductor integrated circuit of claim 1, wherein
the first protection circuit block includes a third ESD protection circuit;
the first ESD protection circuit is connected between the first high-voltage power supply line and the third high-voltage power supply line; and
the third ESD protection circuit is connected between the first low-voltage power supply line and the third low-voltage power supply line.

3. The semiconductor integrated circuit of claim 2, wherein
the first protection circuit block includes fourth and fifth ESD protection circuits;
the fourth ESD protection circuit is connected between the first high-voltage power supply line and the third low-voltage power supply line; and
the fifth ESD protection circuit is connected between the first low-voltage power supply line and the third high-voltage power supply line.

4. The semiconductor integrated circuit of claim 1, wherein
the second protection circuit block includes a sixth ESD protection circuit;
the second ESD protection circuit is connected between the second high-voltage power supply line and the third high-voltage power supply line; and
the sixth ESD protection circuit is connected between the second low-voltage power supply line and the third low-voltage power supply line.

5. The semiconductor integrated circuit of claim 4, wherein
the second protection circuit block includes seventh and eighth ESD protection circuits;
the seventh ESD protection circuit is connected between the second low-voltage power supply line and the third high-voltage power supply line; and
the eighth ESD protection circuit is connected between the second high-voltage power supply line and the third low-voltage power supply line.

6. The semiconductor integrated circuit of claim 1, wherein
the first functional circuit block includes a ninth ESD protection circuit connected between the first high-voltage power supply line and the first low-voltage power supply line;
the second functional circuit block includes a tenth ESD protection circuit connected between the second high-voltage power supply line and the second low-voltage power supply line; and
the relay circuit block includes an eleventh ESD protection circuit connected between the third high-voltage power supply line and the third low-voltage power supply line.

7. The semiconductor integrated circuit of claim 1, wherein
the relay circuit is an inverter circuit.

8. The semiconductor integrated circuit of claim 1, wherein
potentials of the first low-voltage power supply line, of the second low-voltage power supply line, and of the third low-voltage power supply line are equal to each other.

9. The semiconductor integrated circuit of claim 1, wherein
potentials of the first high-voltage power supply line, of the second high-voltage power supply line, and of the third high-voltage power supply line are equal to each other.

10. The semiconductor integrated circuit of claim 1, wherein,
when applying ESD current to the first high-voltage power supply line, current-voltage properties of the ESD protection circuits provided in the first protection circuit block are set so that ESD voltage applied between the first high-voltage power supply line and the third low-voltage power supply line is lower than breakdown voltage of an input terminal of the relay circuit; and
current-voltage properties of the ESD protection circuits provided in the second protection circuit block are set so that ESD voltage applied between the third high-voltage power supply line and the second low-voltage power supply line is lower than breakdown voltage of the input terminal of the second functional circuit.
